(19) United States
(12) Patent Application Publication
(10) Pub. No.: US 2004/0023105 A1
(43) Pub. Date: Feb. 5, 2004

(54) Process for the manufacture of catalyst-coated substrates and water-based catalyst inks for use therefor

(75) Inventors: Claus-Rupert Hohenthanner, Hanau (DE); Andre Mecklenburg, Hanau (DE); Markus Kramling, Friedberg (DE)

Correspondence Address: KALOW & SPRINGUT LLP, 488 MADISON AVENUE, 19TH FLOOR, NEW YORK, NY, 10022, US

(73) Assignee: OMG AG & Co. KG, Hanau-Wolfgang (DE)

(21) Appl. No.: 10/627,238

(22) Filed: Jul. 24, 2003

(30) Foreign Application Priority Data
Jul. 31, 2002 (EP) 02017238.3

(51) Int. Cl. H01M 4/86; H01M 8/10; H01M 4/88; B05D 5/12

(52) U.S. Cl. 429/44; 427/115; 502/101; 429/30

(57) ABSTRACT

The present invention relates to the field of electrochemical cells and fuel cells, and more specifically to polymer-electrolyte-membrane (PEM) fuel cells. It provides a process for the manufacture of catalyst-coated substrates for membrane fuel cells. The catalyst-coated substrates (e.g. catalyst-coated membranes (“CCMs”), catalyst-coated backings (“CCBs”) and catalyst-coated tapes) are manufactured in a new process comprising the coating of the substrate with a water-based catalyst ink in a compartment maintaining controlled humidity and temperature. After deposition of the ink, the substrate is subjected to a leveling process at controlled humidity and temperature conditions. Very smooth and uniform catalyst layers are obtained and the production process is improved. The catalyst-coated membranes (CCMs), catalyst-coated backings (CCBs) and catalyst-coated tapes manufactured according to this process are used in the production of three-layer and five-layer MEAs. These MEAs find use in PEMFC and DMFC stacks.

### FIELD OF INVENTION

The present invention relates to the field of electrochemical cells and fuel cells, and more specifically to polymer-electrolyte-membrane fuel cells (PEMFC) and direct methanol fuel cells (DMFC).

### BACKGROUND OF THE INVENTION

Fuel cells convert fuel and oxidizing agents into electricity, heat and water at two spatially separated electrodes. The energy conversion process in fuel cells is distinguished by its particularly high efficiency. For this reason, fuel cells are becoming of increasing importance for mobile, stationary and portable applications.

Of the various fuel cells that exist, the polymer electrolyte membrane fuel cell (PEMFC) and the direct methanol fuel cell (DMFC, a variation of the PEMFC, powered directly by methanol instead of hydrogen) are often chosen for use as energy converting devices because of their compact design, their power density and their high efficiency. The technology of fuel cells is broadly described in the literature, see for example K. Kordesch and G. Simader, “Fuel Cells and its Applications,” VCH Verlag Chemie, Weinheim (Germany) 1996. By way of example, when operating a fuel cell, hydrogen or a hydrogen-rich gas may, for example, be used as the fuel, and oxygen or air may, for example, be used as the oxidizing agent.

In the following section, the technical terms used in the present patent application are described in greater detail:

A “catalyst-coated membrane” (hereinafter abbreviated “CCM”) consists of a polymer electrolyte membrane that is provided on each side with a catalytically active layer. One of the layers takes the form of an anode for the oxidation of hydrogen and the other layer takes the form of a cathode for the reduction of oxygen. As the CCM consists of three layers (anode catalyst layer, ionomer membrane and cathode catalyst layer), it is often referred to as “three-layer MEA.”“Gas diffusion layers” (“GDLs”), sometimes referred to as gas diffusion substrates or backings, are placed onto the anode and cathode layers of the CCM in order to bring the gaseous reaction media (hydrogen and air) to the catalytically active layers while, at the same time, to establish an electrical contact. GDLs usually consist of carbon-based substrates, such as carbon fibre paper or carbon fabric, which are highly porous and provide the reaction gases with good access to the electrodes. Furthermore, they are hydrophobic, which enables them to remove the produced water from the fuel cell.

Optionally, GDLs can be coated with a microlayer to improve the contact to the membrane. Additionally, they can be tailored specifically into anode-type GDLs or cathode-type GDLs, depending on into which side they are to be built in a MEA. Furthermore, they can be coated with a catalyst layer, and subsequently laminated to the ionomer membrane. These catalyst-coated GDLs are frequently referred to as “catalyst-coated backings” (abbreviated “CCBs”) or gas diffusion electrodes (“GDEs”).

A “membrane-electrode-assembly” (“five-layer MEA”) is the central component in a polymer-electrolyte-membrane (PEM) fuel cell and consists of five layers: the anode GDL, the anode catalyst layer, the ionomer membrane, the cathode catalyst layer and the cathode GDL. A MEA can be manufactured by combining a CCM with two GDLs (on the anode and the cathode side) or, alternatively, by combining an ionomer membrane with two catalyst-coated backings (CCBs) at the anode and the cathode sides. In both cases, a five-layer MEA product is obtained.

The anode and cathode catalyst layers contain electrocatalysts that catalyze the respective reactions (e.g., oxidation of hydrogen at the anode and reduction of oxygen at the cathode). Preferably, the metals of the platinum group of the periodic table are used as the catalytically active components. For the most part, supported catalysts are used in which the catalytically active platinum group metals have been fixed in nano-sized particle form to the surface of a conductive support material. The average particle size of the platinum group metal is between about 1 and 10 nm. However, carbon blacks with particle sizes of 10 to 100 nm and high electrical conductivity have also proven to be suitable as support materials.

The polymer electrolyte membrane consists of proton-conducting polymer materials. These materials are also referred to below as ionomer membranes. Tetrafluoroethylene-fluorovinyl-ether copolymer with sulfonic acid groups is preferably used. This material is marketed for example, by E. I. DuPont under the trade name Nafion®. However, other, especially fluorine-free ionomer materials such as sulfonated polyether ketones or aryl ketones or polybenzimidazoles may also be used. Suitable ionomer materials are described by 0. Savadogo in “Journal of New Materials for Electrochemical Systems” 1,47-66 (1998). For use in fuel cells, these membranes generally have a thickness between 10 and 200 μm.

In the “CCM-technology,” the catalyst layers may be applied directly onto the ionomer membrane resulting in a catalyst-coated membrane (CCM). This method is described, for example, in EP 1 037 295 B1, EP 1 176 652 A2 and other pending applications of the applicant.

Alternatively, in the “CCB-technology,” the catalyst layers may be applied to the GDL (or “backing”) substrates. Two CCBs are then laminated with an ionomer membrane to yield the five-layer MEA.

In a third route, sometimes referred to as the “Decal method” and described, for example, in EP 0 600 888 B 1, the catalyst layers are first applied to inert substrates, for example, a PTFE sheet or blank, dried and then transferred to the surface of an ionomer membrane by means of hot-pressing. The CCMs made by this method are combined with GDLs to form a five-layer MEA.

In the aforementioned methods, the catalytic portion of a catalyst may be applied as a catalyst ink. One class of catalyst inks comprises the water-based catalyst inks, which are well known in the literature. For example, EP 731 520 Al discloses an ink containing a catalyst, an ionomer, water and optionally up to 10 wt. % of additional organic components. This ink reveals a weak adhesion, predominantly to the surface of ionomer membranes. Furthermore, its leveling and wetting characteristics are very poor. Therefore, ink deposits form that possess a very rough surface and do not wet the substrate completely. A detailed process for the application of these inks is not disclosed.

EP 1 176 652 A2 is directed to catalyst inks that contain water and linear dialcohols as organic solvents up to a concentration of 50 wt. %. However, a process for use of these inks is not disclosed.

Additional drawbacks with water-based inks exist on the processing and manufacturing side. The main drawback is the short screen-life of the ink due to rapid evaporation of the main solvent water. This leads to an increase of ink viscosity, which in turn results in an increase of ink deposits on the substrate over the period of operation. Furthermore, the ink runs dry very quickly on the screen, which causes clogging of the screen. Additionally, the print quality is affected, since a poor leveling of the thickened ink occurs and results in weak adhesion to the substrate material.

There have been various efforts made to overcome the drawbacks associated with water-based inks. However, none of these efforts adequately address fuel cell technology or catalyst-containing inks for fuel cell applications.

For example, in DE-OS 2 105 742, a printing process suitable for inks with rapidly evaporating and toxic solvents is disclosed. A closed compartment above the screen is applied to the screen-printing machine to overcome these problems, and a device is added to maintain a saturated atmosphere of solvent above the screen.

In WO 93/03103, water-based chemical compositions suitable for screen-printing are described. A method of screen-printing of these water-based inks, comprising saturating the volume above the printing surface with water vapor, is claimed. This printing method applies to water-based color ink compositions for printing on, for example, textile materials, paper or plastic substrates. However, there is no distinct step disclosed that is directed to leveling the product.

Thus, there is a need to develop a better process for the application of catalyst inks to substrates. The present invention provides one solution.

### SUMMARY OF THE INVENTION

The present invention is directed to processes for manufacturing catalyst-coated substrates and uses for these substrates. The catalyst-coated substrates, e.g., catalyst-coated membranes (“CCMs”), catalyst-coated backings (“CCBs”) and other catalyst-coated tape materials, are manufactured in a process that comprises the application of water-based catalyst inks to substrates under controlled relative humidity and temperature. In a subsequent step, the substrates are held at a controlled humidity and temperature for a certain period of time to achieve leveling of the ink deposits. Following this leveling step is a drying step, and after the drying step, very smooth catalyst layers are obtained.

Generally, the present invention provides a process for applying a catalyst ink onto a substrate, said process comprising:

(a) coating a substrate with a catalyst ink under conditions of controlled temperature and humidity to form a deposited catalyst ink, wherein said catalyst ink comprises an electrocatalyst, an ionomer and water;

(b) leveling the deposited catalyst ink under conditions of controlled temperature and humidity to form a catalyst-coated substrate; and

(c) drying the catalyst-coated substrate.

The coating and leveling steps are preferably preformed in a coating compartment and a leveling compartment, respectively. The drying step is preferably performed at elevated temperatures. For example, the drying step may be performed in the temperature range of 40 to 150° C. for one to ten minutes.

Furthermore, the present invention provides a device for the application of catalyst inks. The device comprises a coating machine, wherein said coating machine is comprised of a coating compartment for catalyst ink application; and a leveling compartment for leveling of the catalyst ink, wherein said device is integrated into a continuous manufacturing line.

The present invention is particularly beneficial for applying water-based catalyst inks onto specialty substrates such as, e.g., ionomer membranes and gas diffusion layers. Further, it is straightforward, simple and fast. Thus, the present invention should be easily scaleable to high-volume manufacturing and applicable to a continuous production line. Last but not least, the process is environmentally safe and sustainable.

The catalyst-coated membranes (CCMs), catalyst-coated backings (CCBs) and catalyst-coated tapes manufactured according to this process can be used for production of three-layer and five-layer membrane-electrode-assemblies (MEAs). These MEAs find use as components for PEMFC and DMFC stacks.

### BRIEF DESCRIPTION OF THE FIGURES

FIG. 1 shows a schematic drawing of a reel-to-reel manufacturing line according to the present invention comprising an integrated coating machine.

FIG. 2 shows possible coating patterns on single sheet substrates a) and on continuous strips b) and c).

### DETAILED DESCRIPTION OF THE INVENTION

The present invention is directed to the application of water-based catalyst inks to various substrates. These inks can be applied by a printing process, (e.g., screen printing, stencil printing, offset printing, etc.,) doctor-blading, brushing, spraying or other known coating techniques.

The present disclosure is not intended to be a treatise on catalyst inks or fuel cells. Readers are referred to appropriate available texts for background on these subjects.

In one embodiment, the present invention provides a process for applying a catalyst ink. The process comprises coating a substrate with the ink, leveling the ink and drying the substrate after the ink has been coated and leveled. Preferably, the coating occurs in a coating compartment and the leveling occurs in a leveling compartment. More preferably, the coating process is performed on a coating machine with a coating compartment while maintaining a controlled humidity in the range of 60 to 100% relative humidity at a temperature in the range of 10 to 60° C. The coated substrate is then subjected to a leveling process in the leveling compartment under humidity and temperature conditions in the same range for 1 to 10 minutes. These steps enable one to form a smooth, uniform catalyst layer with very low surface roughness.

In a second embodiment, the present invention uses improved water-based catalyst inks to coat substrates. These water-based catalyst ink compositions comprise an electrocatalyst, an ionomer resin, water (as a main solvent) and a surfactant with a vapor pressure in the range of 1 to 600 Pascal (Pa) at room temperature (20-25° C.). The surfactants improve the wetting and leveling characteristics of the ink, particularly to hydrophobic substrate materials, such as polymer films or PTFE-impregnated backings. The high vapor pressure facilitates the removal of the surfactants after the leveling process when exposed to slightly elevated temperatures in the drying stage. As a consequence, less surfactant remains in the printed electrode layers; this in turn leads to an improvement in electrical performance of the electrode layers, and consequently, of the MEAs manufactured with these inks.

Suitable surfactants for the present invention are materials with vapor pressures in the range of 1 to 600 Pa, preferably in the range of 400 to 600 Pa at 20-25° C. Examples of suitable classes of surfactants include but are not limited to non-ionic, anionic or cationic surfactants, such as fluorinated wetting agents (Fluorad® types, manufactured by 3M Co.), tetramethyl-decyn-diol based wetting agents (Surfynol types, manufactured by Air Products and Chemicals Inc.), soya-lecithin based wetting agents or phospho-amino-lipoides and the like. The vapor pressure of the materials can be determined by standard techniques. Lists of such data are also available e.g., “CRC Handbook of Chemistry and Physics,” CRC Press LLC, Boca Raton (USA). The amount of surfactant added is preferably in the range of 0.1 to 20 wt. % based on the total composition of the catalyst ink, more preferably between 0.1 and 10 wt. %. In addition, the water-based ink may contain additional organic solvents, additives, defoamers, pore forming agents and the like. Mixtures of the listed ingredients, as well as mixtures of various surfactants may also be used.

A preferred water-based catalyst ink contains 5 to 75 wt. % of electrocatalyst, 10 to 75 wt. % of ionomer solution (water based or organic solvent based), 10 to 75 wt. % of deionized water, 0 to 50 wt. % of organic solvents and 0.1 to 20 wt. % of surfactant with a vapor pressure of 1 to 600 Pa. Suitable organic solvents include but are not limited to glycols (e.g., ethylene glycol, diethylene glycol, propylene glycol, butanediol, and mixtures thereof), alcohols (e.g., C₁₋₄ alcohols, and mixtures thereof), esters (e.g., esters of C₁₋₄ alcohols with C₁₋₄ carboxylic acids and mixtures thereof), aromatic solvents (e.g., benzene or toluene), and aprotic dipolar solvents such as N-methylpyrrolidone, ethylene carbonate, propylene carbonate, DMSO and the like. Preferably glycols are employed.

The ionomer solutions are commercially available and typically comprise an ionomer in water or an organic solvent. Generally, they contain 5 to 20 wt.-% ionomer. Depending on the type of electrocatalyst, the weight ratio of ionomer to electrocatalyst is usually from 1:1 to 1:15, preferably from 1:1 to 1:10 and more preferably from 1:2 to 1:6. The ionomer solution is diluted with water and optionally an additional organic solvent to ensure that the resultant ink can be processed.

Suitable electrocatalysts are e.g., carbon black supported precious metal-based catalysts such as Pt/C or PtRu/C. However, precious metal powders and precious metal blacks, as well as inorganic oxides containing precious or non-precious metals can be used.

In a third embodiment of the present invention, the direct coating of an ionomer membrane is performed in a continuous reel-to-reel process. A screen-printer comprising a coating compartment with controlled relative humidity is used to apply the catalyst ink, which may, for example, be the catalyst ink described in the second embodiment. After printing, the catalyst ink is leveled in a second compartment (leveling compartment) with the same relative humidity and at the same temperature and subsequently dried. According to this process, a catalyst-coated membrane (CCM) is manufactured.

In a fourth embodiment of the present invention, the catalyst ink, which, for example, may be the catalyst ink described in the second embodiment, is used to catalyze gas diffusion layers (GDLs) based on carbon materials. Again, the application process is performed with a screen-printing device comprising a compartment with controlled relative humidity and a separate compartment for leveling of the ink; however, the process is conducted discontinuously using individual sheets of carbon fiber substrates rather than substrates in a roll form.

In a fifth embodiment of the present invention, the catalyst ink, which may be, for example, the catalyst ink described in the second embodiment, is deposited onto an inert transfer medium (for example, polyester film or tape) in a continuous reel-to-reel process. After leveling and drying, the catalyst deposit is transferred from the polymer film substrate to the surface of the ionomer membrane by means of a hot-pressing/lamination process. The CCM manufactured according to this embodiment is subsequently sandwiched between two uncatalyzed GDLs to yield the 5-layer MEA.

Variations of these embodiments are possible. For example, the CCM can be prepared in a combined process by a direct coating of the anode layer by screen-printing followed by an indirect coating of the cathode layer by a tape-transfer process using a catalyst-coated tape and a hot-pressing step. Furthermore, the coating of GDLs as described in the fourth embodiment can also be performed in a reel-to-reel process.

In addition to ionomer membranes and carbon fiber substrates, a range of different substrate materials can be coated in the process with water-based catalyst inks. Examples of substrates include but are not limited to hydrophobic polymer films (such as polyester, polyimide, polyethylene, PTFE-coated films, etc.), transfer tape materials, paper-based materials, decal substrates, metal substrate tapes, and the like. These materials can be used in roll form or as individual sheets. Additionally, different methods for the application of catalyst inks can be employed (e.g., stencil printing, offset-printing, transfer printing, doctor-blading, brushing, spraying or other known coating techniques).

As for ionomer membranes, various types, including but not limited to solid uniform membranes, supported membranes on a polymer film, bi-layer membranes, reinforced ionomer membranes, as well as composite membranes can be used.

As for GDLs, various commercially available materials known in fuel cell technology can be processed. Examples include but are not limited to carbon paper, carbon fibers, carbon cloth, woven or non-woven carbon mesh, needled felt, knitted fabric, etc. The porous carbon type supports may be wet proofed and may contain a microlayer.

The catalyst-coated substrates of the present invention may, for example, be used to form catalyst-coated membranes, catalyst-coated gas diffusion substrates and catalyst-coated polymer films. The composition may in turn be used to form membrane electrode assemblies, which may, for example, be used in a PEMFC or DMFC.

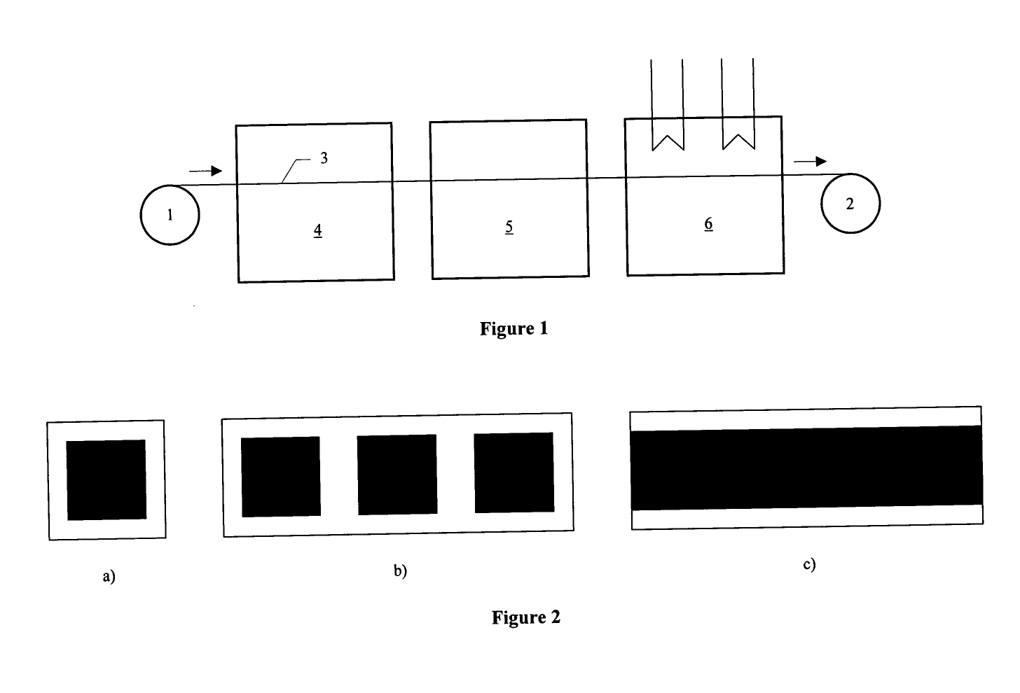

FIG. 1 and FIG. 2 are intended for further explanation of the present invention.

FIG. 1 shows a schematic drawing of a reel-to-reel manufacturing line according to the present invention comprising an integrated coating machine. The continuous strip substrate (3) is fed to the screen printer from a feeding roll (1) and guided through three different treatment compartments and then wound up on a receiving roll (2). The first treatment compartment is the coating compartment (4) for printing under controlled humidity and temperature. The strip substrate is then introduced into the leveling compartment (5), which also provides controlled humidity and temperature. Finally, the printed catalyst layers are dried in a drying compartment (6).

The manufacturing line from FIG. 1 allows printing and leveling under different atmospheres. If the atmospheres for printing and leveling are the same, then the coating and leveling compartment can be combined to form one large compartment comprising a coating section and a leveling section.

FIG. 2 shows possible coating patterns on single sheet substrates a), and on continuous strips b) and c). For coating single sheet substrates, the feeding roll (1) in FIG. 1 must be replaced with an appropriate sheet feeding device and further transport devices for transporting single sheets through the manufacturing line must be provided. Receiving roll (2) in FIG. 1 must be replaced with a single sheet-collecting device.

The following examples describe the invention in more detail. These examples are presented to aid in an understanding of the present invention and are not intended and should not be construed, to limit the invention in any way.

### Example 1

This example describes the direct coating of an ionomer membrane using a water-based catalyst ink (preparation of a catalyst-coated membrane, CCM). A water-based catalyst ink was formulated according to the following composition:

| | |
|---|---|
| 20.0 g | Electrocatalyst Elyst A 40 (40% Pt/C, OMG AG, Hanau) |
| 63.8 g | Nafion ® Jonomer solution (15 wt. % in water) |
| 15.0 g | Dipropylene glycol |
| 1.2 g | Surfactant Surfynol 420 (Air Products and Chemicals, Inc.) |
| 100.0 g | |

The precious metal based catalyst was thoroughly mixed with the Nafion® solution, then the glycol solvent and the surfactant were added, and the catalyst ink was prepared by means of a stirring device. The coating of catalyst ink onto an ionomer membrane strip (Nafion® 112, thickness 50 microns, width 0.5 m, length 10 m) was performed on a continuous reel-to-reel-coating machine as disclosed in EP 1 037 295 B 1. The active area to be printed on the front and the back side of the membrane was 100 cm² (10×10 cm). The squeegee area of the screen-printing machine was covered with a sealed compartment, in which a constant relative humidity of 90% at a temperature of 25° C. was maintained. To that purpose, water vapor mist was continuously added to the compartment by means of an ultrasonic nebulizer. Additionally, a separate leveling chamber was integrated into the reel-to-reel equipment line, which was also supplied with water vapor from the nebulizer. After the printing step, the membrane strip was transported through the separate leveling chamber with controlled humidity (90% rel. humidity, 25° C., residence time 2 minutes). The individual print deposits of the screen mesh pattern were leveled and a smooth, continuous catalyst layer was formed. After having passed the leveling chamber, the coated membrane was dried in a belt dryer by means of hot air. The drying conditions were 100° C. for 5 minutes. The Pt-loading after the first print was 0.2 mg Pt/cm².

Subsequently, a second printing step was conducted on the back side of the ionomer membrane. The parameters for printing, leveling and drying were identical to the first run. The total precious metal loading of the membrane after two printing steps (on front and back side) was 0.5 mg Pt/cm². The CCM was cut to an active area of 50 cm² and assembled with two un-catalyzed GDLs to form a MEA showing very good results in the PEMFC performance test (hydrogen/air operation, ref. to table 1).

### Example 2

The catalyst ink described in example 1 was used for coating of a GDL substrate. The GDL substrate was prepared as follows: A sheet of carbon fiber paper (length 80 cm, width 80 cm thickness 350 μm, porosity 85%; supplied by SGL Carbon Group, type SIGRACET®) was wet proofed with a water-based PTFE solution (type Hostaflon TF 5032, Dyneon, Gendorf) to a PTFE content of 10 wt. %. After that, a microlayer, consisting of carbon black and PTFE was applied to one side of the carbon fiber paper. Then the microlayer coated surface of the GDL substrate was coated with the water-based catalyst ink by a screen-printing process. The squeegee area of the screen-printing machine was covered with a sealed compartment in which a constant relative humidity of 95% at a temperature of 25° C. was maintained. To that purpose, water vapor mist was continuously added to the compartment by means of an ultrasonic nebulizer. After the printing step, the substrate was transferred to a leveling chamber and allowed to level for 2 minutes at 95% relative humidity at 25° C. Finally, the catalyzed GDL was dried at 120° C. for 10 minutes. An ionomer membrane (Nafion® 112) was sandwiched between two of the catalyzed GDLs (cut to an active area of 50 cm²) and hot-pressed at 150° C. and 15 bar pressure for 20 seconds to form a 5-layer MEA. This MEA showed very good results in the PEMFC electrochemical testing (ref. to table 1).

Electrochemical Testing

The CCMs/MEAs were tested in a PEMFC single cell with an active area of 50 cm² running on hydrogen/air feed gases. The cell temperature was 80° C., the operating gas pressure was 1.5 bar. Anode humidification was 80° C., cathode humidification was 60° C. and stoichiometries were 1.5 (anode)/2 (cathode). As shown in table 1, the MEAs based on CCMs and CCBs manufactured according to the present invention possess a high cell voltage in the range of 670 mV at a current density of 600 mA/cm² (this results in a power density of about 0.4 W/cm²).

TABLE 1
Results of electrochemical testing of five-layer MEAs

| | Example 1 | Example 2 |
|---|---|---|
| Cell Voltage @ | 670 | 680 |
| 600 mA/cm² (mV) | | |

What is claimed:

1. A process for applying a catalyst ink onto a substrate, said process comprising:
(a) coating a substrate with a catalyst ink under conditions of controlled humidity and temperature to form a deposited catalyst ink on said substrate, wherein said catalyst ink comprises an electrocatalyst, an ionomer and water;
(b) leveling the deposited catalyst ink under conditions of controlled humidity and temperature to form a catalyst-coated substrate; and
(c) drying the catalyst-coated substrate at an elevated temperature.

2. The process according to claim 1, wherein said catalyst ink further comprises an organic solvent.

3. The process according to claim 2, wherein said catalyst ink further comprises a surfactant with a pressure between 1 and 600 Pascal.

4. The process according to claim 3, wherein the substrate is selected from the group consisting of a polymer film, an ionomer membrane, a carbon fiber, a carbon cloth, a carbon felt and a paper-type material.

5. The process according to claim 4, wherein said substrate is present in individual sheet or in continuous roll form.

6. The process according to claim 1, wherein the coating occurs in a coating compartment and the leveling occurs in a leveling compartment, and wherein the humidity in the coating compartment is maintained at 60 to 100% relative humidity and a temperature in the range of 10 to 60° C., and the humidity in the leveling compartment is maintained at 60 to 100% relative humidity and at a temperature in the range of 10 to 60° C.

7. The process according to claim 6, wherein the leveling of the deposited catalyst ink is performed for a period of 1 to 10 minutes.

8. The process according to claim 7, wherein the drying of the catalyst ink is performed at a temperature in the range of 40 to 150° C. for 1 to 10 minutes.

9. A device for the application of catalyst inks, said device comprising a coating machine, wherein said coating machine is comprised of:
(a) a coating compartment for catalyst ink application; and
(b) a leveling compartment for leveling of the catalyst ink, and wherein said device is integrated into a continuous manufacturing line.

10. The device according to claim 9, wherein the coating compartment and the leveling compartment are a single compartment or separate compartments.

11. A composition comprised of a catalyst-coated membrane, wherein said catalyst-coated membrane is comprised of the catalyst-coated substrate produced according the process of claim 1.

11. A composition comprised of a catalyst-coated gas diffusion substrate, wherein said catalyst-coated gas diffusion substrate is comprised of the catalyst-coated substrate produced according to the process of claim 1.

12. A composition comprised of a catalyst-coated polymer film wherein said catalyst-coated polymer film is comprised of the catalyst-coated substrate produced according to the process of claim 1.

13. A membrane-electrode-assembly comprising the catalyst-coated membrane of claim 10.

14. A membrane-electrode-assembly comprising the catalyst-coated gas diffusion substrate of claim 11.

15. A membrane-electrode-assembly comprising the catalyst-coated polymer film of claim 12.

16. A method of using the membrane-electrode-assembly of claim 14, comprising operating a PEMEC or DMFC fuel stack, wherein said fuel stack is comprised of said membrane-electrode assembly.

17. A method of using the membrane-electrode-assembly of claim 15, comprising operating a PEMFC or DMFC fuel stack, wherein said fuel stack is comprised of said membrane-electrode assembly

18. A method of using the membrane-electrode-assembly of claim 16, comprising operating a PEMFC or DMFC fuel stack, wherein said fuel stack is comprised of said membrane-electrode assembly
